(19) United States
(12) Patent Application Publication
(10) Pub. No.: US 2013/0030783 A1
(43) Pub. Date: Jan. 31, 2013

(54) PARAMETER DETERMINING METHOD AND DEVICE

(71) Applicants: Junya Nishiguchi, Tokyo (JP); Tomohiro Konda, Tokyo (JP); Hirotaka Nakayama, Kyoto (JP); Yeboon Yun, Osaka (JP)

(72) Inventors: Junya Nishiguchi, Tokyo (JP); Tomohiro Konda, Tokyo (JP); Hirotaka Nakayama, Kyoto (JP); Yeboon Yun, Osaka (JP)

(73) Assignee: AZBIL CORPORATION, Tokyo (JP)

(21) Appl. No.: 13/472,982

(22) Filed: May 16, 2012

(30) Foreign Application Priority Data
Jul. 26, 2011 (JP) 2011-162843

(51) Int. Cl. G06G 7/62

(52) U.S. Cl. 703/13

(57) ABSTRACT

An approximated objective function value calculator calculates individual estimated values for an evaluation parameter corresponding to individual values of a controlled parameter where the value of a non-controlled parameter is held constant at the current value in an approximated objective function estimated by an approximated objective function estimator. A proximity distance calculator calculates, as a proximity distance s for each individual value for the controlled parameter, a distance from each individual value for the controlled parameter, in a case where the value of the non-controlled parameter is held constant, to the analysis data having the nearest distance when projected onto an input variable space defined by the controlled parameter and the non-controlled parameter. An additional measurement point determining indicator calculator calculates an additional measurement point determining indicator P corresponding to each individual value of the controlled parameter as P=estimated value−α×s.

### FIELD OF TECHNOLOGY

The present invention relates to a parameter determining method and device for estimating an objective function based on data acquired from an applicable system to determine a value for a parameter that has a high probability of improving the optimal value in an objective function that is updated by the next data acquired from the approximated objective function.

### PRIOR ART

Conventionally, have been known learning-type optimizing methods for performing optimization control of applicable systems through estimating objective functions by progressively learning data, acquired from the applicable system, to calculate a value for a parameter that minimizes or maximizes the approximated objective function, to set the calculated parameter value as the optimal setting value. (See, for example, Patent Document 1.)

Note that in the learning-type optimizing method, the objective function is a function that indicates the relationship between an indicator for evaluating the applicable system (for example, the costs, amount of energy consumed, amount of carbon dioxide exhausted, operating efficiency, or the like, accompanying the operation of the applicable system) and an input variable (an input parameter). In this objective function, if it is possible to calculate the input parameter value that will minimize or maximize the indicator for evaluating the applicable system (the value of the objective function), to set that input parameter value as the optimal setting value, then it will be possible to perform optimized control all of the applicable system.

An objective function that is estimated based on data acquired from the applicable system is called an approximated objective function, and calculating the input parameter value corresponding to the optimal value in this estimated approximated objective function is known as parameter optimization.

For example, in air conditioning/heating systems (hereinafter termed simply “air-conditioning systems”), which account for approximately 40% of total energy consumption in a building, parameter optimization is able to achieve energy conservation and CO₂ reduction in an existing facility, and thus is very beneficial for the building owners, and the like. Moreover, learning, from the data acquired on-line from the system, an approximated objective function to be used when optimizing the parameters enables the provision of an air-conditioning system that is able to respond to changes in equipment and changes in operations without requiring detailed information such as equipment specifications, facilities plans, and the like.

In this type of parameter optimizing method that uses an approximated objective function, the nature of the data acquired from the applicable system has a large effect on performance. In particular, because the amount of data that has been acquired from the applicable system at the time of initial implementation is small, the estimated approximated objective function will lack reliability. Because of this, in some cases the true optimal value will not be found even if the parameter from the approximated objective function are optimized continuously.

This problem will be explained using FIG. 9. Note that for ease in explanation, there will only be a single input parameter in this example. In this figure, the horizontal axis is the value of the input parameter (the setting value), and the vertical axis is the value of the objective function (the objective function value), where D1 through D6 are data acquired from the applicable system (obtained data), the curve I shown by the solid line is the approximated objective function estimated from the data D1 through D6, the curve II shown by the dotted line is the true objective function, MINx is the minimum value of (the optimal value) in the approximated objective function I, and MIN_{S} is the minimum value (the true optimal value) in the true objective function II. In this case, the value of the input parameter corresponding to the true optimal value MIN_{S} is positioned in the sparse portion wherein there is little data, and thus the reliability of the approximated objective function I is low, and so even if the value of the input parameter that would minimize the approximated objective function I were to be calculated continuously, still the value of the input parameter corresponding to the minimum value MINx for the approximated objective function I would not approach the setting value corresponding to the true optimal value MIN_{S}, meaning that the true optimal value would not be found.

In contrast, in the field of optimal design, there are known methods for determining the input variable value for the obtained data that is to be acquired next based on an indicator that takes into account both the local characteristics that indicate optimization and broader-region characteristics that indicate the sparseness of the input variable values for the obtained data. For example, in the EGO (Efficient Global Optimization) described in Non-Patent Document 1, an approximated objective function is estimated from the obtained data, and an indicator known as the EI (Expected Improvement) is defined for the estimated approximated objective function, to indicate the probability that there will be an improvement in the optimal value that has already been obtained in the approximated objective function. This EI is an indicator that takes into account both the local characteristics that indicate an optimum and broader-region characteristics that show the sparseness of the sample points, that is, it is an indicator that takes into account the reduction in the probability that the true optimal value has been overlooked through the use of the optimal value for the approximated objective function that has already been defined or the use of the samples in the region wherein the samples are sparse.

FIG. 10 shows an example of an EI that is defined for an approximated objective function. For ease in explanation, there will only be a single input parameter in this example as well. In this figure, the horizontal axis is the value of the input parameter (the setting value), the vertical axis on the left is the value of the objective function (the objective function value), and the vertical axis on the right is the value of EI, where D1 through D5 are data acquired from the applicable system (obtained data), the curve I shown by the solid line is the approximated objective function estimated from the data D1 through D5, the curve II shown by the dotted line is the true objective function, and the curve III that is shown by the dashed line is the EI.

In EGO, an indicator that indicates the likelihood of the existence of the true optimal value based on the magnitude of the EI, that is, calculated from the approximated objective function, and an indicator that indicates the uncertainty of the approximated objective function, are combined to calculate a value for the next input parameter that has a high probability of improving the optimal value for the approximated objective function when updated by the next obtained data, to acquire new data using the calculated input parameter value as the setting value, to estimate the approximated objective function again. Data can be acquired efficiently through such iteration, enabling a reduction in the probability that the true optimal value has been overlooked, doing so with a small number of data.

### PRIOR ART DOCUMENTS

### Patent Documents

[Patent Document 1] Japanese Unexamined Patent Application Publication 2010-236786
[Patent Document 2] Japanese Unexamined Patent Application Publication H6-95880 (Japanese Patent 2632117)

### Non-Patent Documents

[Non-Patent Document 1] D. R. Jones, et al: Efficient Global Optimization of Expensive Black-Box functions, Journal of Global Optimization, vol. 13, no. 4, pp. 455-492, 1998.

### DISCLOSURE OF THE INVENTION

### Problem Solved by the Present Invention

However, in EGO, described above, there is an assumption that all of the input variables are parameters that are subject to setting and modification (that is, they are controlled parameters), so it is difficult to apply to a system wherein input variables include parameters that are not subject to setting and modification (non-controlled parameters).

In such a system, the non-controlled parameters are not subject to setting and modification, so it is not always possible to obtain the data for the points one wishes to obtain. As described above, the EI is defined as the probability of improving the optimal value that has already been acquired (a known optimal value). Because of this, the issue is that of the non-controlled parameter conditions that define the known optimal value. When the known optimal value is defined by conditions for the entire region over which the non-controlled parameters are defined, then typically a non-controlled parameter that corresponds to the known optimal value will be different from the specific value, which is a constant, and there may not be a controlled parameter that is able to improve the known optimal value. In this case, the EI will be zero regardless of the value that is set for the controlled parameter, implying that EI is not defined correctly. On the other hand, when a known optimal value is defined by a condition for a specific value wherein a non-controlled variable is constant, then the EI cannot be defined because there will be no historic obtained data under that circumstance.

In this way, in a system wherein the input variables include parameters that are not subject to updating settings (non-controlled parameters), in some cases the EI cannot be set appropriately relative to the approximated objective function that has been estimated. In EGO, the EI is a critically important indicator, and if it is not possible to define the EI, then it will not be possible to determine the value of a controlled parameter that will have a high probability of further improving the optimal value in the approximated objective function through obtaining the subsequent data.

The present invention is to solve this type of problem, and the object thereof is to provide a parameter determining method and device able to determine a parameter value that has a high probability of further improving an optimal value in an approximated objective function, through the next obtained data, to obtain additional data efficiently to enable the reduction of the probability of overlooking the true optimal value, with a small number of data, even in a system wherein the input variables include a parameter that is not subject to setting and modification.

### Means for Solving the Problem

In order to achieve such an object, the parameter setting method according to the present invention comprises: a first step for estimating, as an approximated objective function, based on data acquired from an applicable system, an objective function that uses, as input variables, a first parameter that is subject to setting and modification, and a second parameter that is not subject to setting and modification; a second step for calculating individual values for the approximated objective function corresponding to individual values for the first parameter in a case wherein the value of the second parameter is kept constant at a specific value; a third step for calculating, as a proximity distance for each individual value for the first parameter, a distance from the individual value of the first parameter to the data that is nearest in distance, projected into an input variable space that is defined by the first parameter and the second parameter; and a fourth step for determining a value for the first parameter based on the individual values of the approximated objective function corresponding to the individual values of the first parameter when the value of the second parameter is held constant at a specific value, calculated in the second step, and on the proximity distances corresponding to the individual values of the first parameter, calculated in the third step.

Moreover, a parameter setting device according to the present invention comprises approximated objective function estimating means for estimating, as an approximated objective function, based on data acquired from an applicable system, an objective function that uses, as input variables, a first parameter that is subject to setting and modification, and a second parameter that is not subject to setting and modification; approximated objective function value calculating means for calculating individual values for the approximated objective function corresponding to individual values for the first parameter in a case wherein the value of the second parameter is kept constant at a specific value; proximity distance calculating means for calculating, as a proximity distance for each individual value for the first parameter, a distance from the individual value of the first parameter to the data that is nearest in distance, projected into an input variable space that is defined by the first parameter and the second parameter; and parameter value determining means for determining a value for the first parameter based on the individual values of the approximated objective function corresponding to the individual values of the first parameter when the value of the second parameter is held constant at a specific value, calculated by the approximated objective function value calculating means, and on the proximity distances corresponding to the individual values of the first parameter, calculated by the proximity distance calculating means.

In the present invention, the data acquired from the applicable system is a set (combination) of “first parameter values,” “second parameter values,” and “objective function values relating to these values.” The “first parameter values” and “second parameter values” are both set in relation to the applicable system, where, in contrast, the “objective function values” are measured or calculated from the results of operating the applicable system based on these “first parameter values” and “second parameter values.”

In the present invention, if the “applicable system” is assumed to be an air-conditioning system, then one may consider the supply water temperature and flow rate, airflow rate, chilled water temperature, supply air temperature, number of refrigeration units in operation, and the like, as examples of the first parameters, and one may consider the outdoor temperature, outdoor humidity, outdoor dew point temperature, outdoor enthalpy, load heating quantity, number of occupants, and the like, as examples of the second parameters. While there may be only a single parameter each for the first parameter and the second parameter (for example, the feed water temperature and the outdoor temperature), in the present invention these parameters are not limited to single parameters, but there may be a plurality of parameters for each.

In the present invention, in contrast to the first parameter being a parameter (a controlled parameter) wherein the value thereof is subject to changes in settings arbitrarily by the operator, control device, or the like, of the applicable system, the second parameter is a parameter (a non-controlled parameter) wherein the value thereof is not subject to modification by the operator, control device, or the like, of the applicable system, such as the outdoor temperature, the number of occupants, or the like.

In the present invention, the “objective function” is a relationship between an indicator for evaluating the applicable system (for example, the cost, amount of energy consumed, amount of carbon dioxide exhausted, operating efficiency, or the like, accompanying the operation of the applicable system), and the first parameter and the second parameter. “Optimized control” addresses the issue of calculating controlled parameters that minimize (or maximize) this indicator. The objective function may be expressed in any form insofar as it provides a correspondence between the first and second parameters, which are the input variables, and the evaluation indicator that is the output variable. For example, while it may be a function that is expressed mathematically, a model that is constructed using a case-based system (referencing, for example, Patent Document 2) also corresponds to this “objective function.”

In the present invention, a case wherein there are m second parameter values (where m is an integer between 1 and M−2, inclusive) that are defined as constants at specific values in an N-dimensional space (where N is an integer no less than 3) that is defined by the first parameter and second parameter (the input variables for the objective function) and the evaluation indicator for the applicable system (the output variable (the evaluation parameter) for the objective function) is equivalent to projecting the N-dimensional space onto an (N-m)-dimensional space. Moreover, in the present invention the “individual values of an approximated objective function corresponding to the individual values of the first parameter when the value of the second parameter is defined as a constant at a specific value” is included in this projection of the N-dimensional space of the approximated objective function onto the (N-m)-dimensional space (or, more intuitively, a “cross-section” in the (N-m)-dimensional space of the approximated objective function).

In the present invention, “distance” is the distance in an N−1-dimensional space (where N is an integer no less than 2) comprising the first parameters and the second parameters (the input variables for the objective function). This “distance” can be expressed in general as a real number that satisfies the so-called trigonometric inequality considering any two points in the N−1-dimensional space, where the Euclidean distance wherein the distance between two points in an n-dimensional space is defined by the following equation is a typical example thereof. Note that in this equation, f, and g, indicate values corresponding to the individual dimensions for the two points in the n-dimensional space.

$$\begin{matrix}[ Expression 1 ] & \\ d ( f , g ) = \sqrt{{\sum }_{i = 1}^{n} {( {f}_{i} - {g}_{i} )}^{2}} & ( 1 )\end{matrix}$$

While of course a Euclidean distance can be used for this “distance” in the present invention, distances other than Euclidean distances may be used instead. Moreover, when calculating the distance, the scales used for the individual parameters are arbitrary, where the distances may be calculated weighted by the values for any of the parameters.

In the present invention, the approximated objective function that has been estimated is estimated from a limited number of data, and it is not certain whether or not it is the true objective function. That is, for a region wherein there is actually no data, the approximated objective function is “uncertain,” where this uncertainty should be of a magnitude in accordance with the “spatial density” of the data used in the derivation. In the present invention, the “proximity distance,” which is defined as the “distance from each individual value for the first parameter to the data with the nearest distance that is projected onto an input variable space defined by the first parameters and the second parameters,” is an indicator indicating the “spatial density” of the data used in estimating the approximated objective function (the sparseness of the data that is the basis for the estimation) for the approximated objective function that is projected onto a reduced-dimensionality space under the constraint of being “a case wherein the second parameter value is defined as a constant at a specific value,” and, by extension, can be considered to be an indicator that indicates the “uncertainty” of the approximated objective function projected onto a reduced-dimensionality space under the constraint of “the second parameter value is defined as a constant at a specific value.” On the other hand, it is necessary to consider an indicator that expresses the possibility of the existence of a true optimal value that can be calculated from the approximated objective function value that has been acquired, and the value of the approximated objective function can be substituted for this. In the present invention, the “proximity distance,” which is an indicator expressing the “uncertainty.” is considered in conjunction with the value of the approximated objective function, to determine the optimal value in an approximated objective function that has already been defined, or to determine the value for the first parameter in a region wherein the obtained data exists only sparsely.

### Effects of the Invention

In the present invention, an objective function that uses, as input variables, a first parameter (a parameter that is subject to modifications of settings) and a second parameter (a parameter that is not subject to modifications of settings) is estimated, based on data acquired from an applicable system, as an approximated objective function, individual values for the approximated objective function corresponding to individual values of the first parameter are calculated for a case wherein the second parameter value is defined as a constant at a specific value, distances from the individual values of the first parameter in the case wherein the second parameter value is defined as a constant at a specific value to the data with the nearest distance that is projected onto a space defined by the first parameter and the second parameter are calculated as proximity distances, and a first parameter value is determined based on individual values of the approximated objective function corresponding to the individual values of the first parameter in the case wherein the second parameter value is defined as a constant at the specific value and on the proximity distances corresponding to the individual values of the first parameter, and thus the indicator that is the proximity distance that indicates the “uncertainty” of the objective function, projected onto the reduced-dimensionality space under the constraint that the value of the second parameter is defined as a constant at a specific value is combined with an indicator that indicates the likelihood of the existence of a true optimal value, calculated from the approximated objective function value that is acquired, to thereby determine the value of the first parameter, making it possible to determine a parameter value that has a high probability of improving the optimal value of the approximated objective function that is updated by the next obtained data, even in a system that includes, within the parameters that are input variables, parameters that are subject to setting and to modification. Doing so makes it possible to perform data sampling efficiently, with a small number of data points, to reduce the likelihood of overlooking a true optimal value.

### BRIEF DESCRIPTION OF THE DRAWINGS

FIG. 1 is a block diagram illustrating the critical portions of one form of embodiment of a parameter determining device used in embodying the parameter determining method according to the present invention.

FIG. 2 is a flowchart for explaining the functions of the various portions in the parameter determining device.

FIG. 3 is a diagram illustrating an example of an approximated objective function estimated in the approximated objective function estimating portion of the parameter setting device.

FIG. 4 is a diagram illustrating an example of a true objective function relating to the approximated objective function estimated in the approximated objective function estimating portion.

FIG. 5 is a diagram for explaining the state wherein the proximity distances are calculated for the individual values of the controlled parameters in the proximity distance calculating portion of the parameter determining device.

FIG. 6 is a diagram illustrating proximity distances for the individual values of controlled parameters, calculated in the proximity distance calculating portion.

FIG. 7 is a diagram for explaining the state wherein an additional measurement point determining indicator is calculated in the additional measurement point determining indicator calculating portion in the parameter determining device.

FIG. 8 is a diagram illustrating an example of changes in the approximated objective function estimated by the approximated objective function estimating portion.

FIG. 9 is a diagram for explaining problem areas in the conventional parameter optimizing method that uses approximated objective functions.

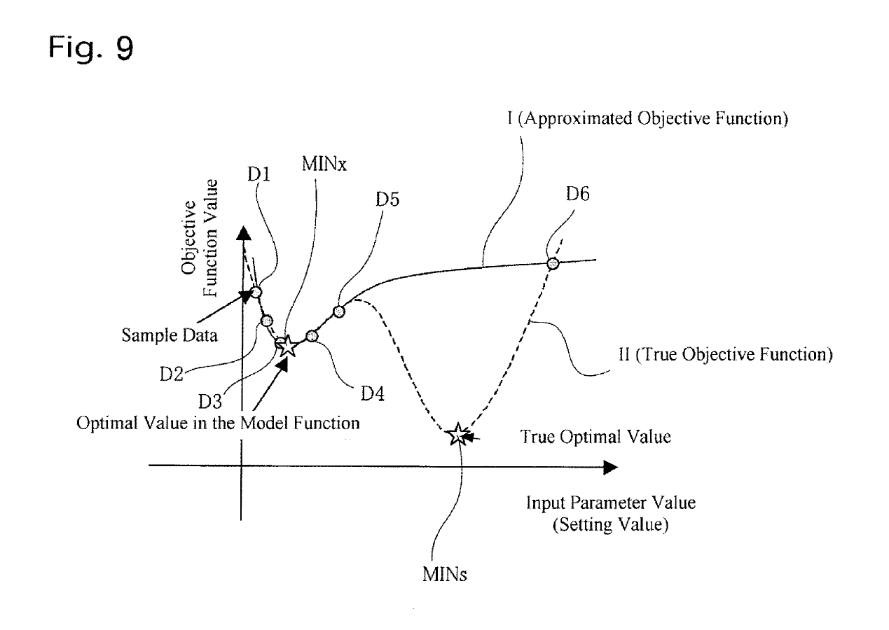

FIG. 10 is a diagram illustrating an example of an EI (and indicator indicating the likelihood of improving an approximated objective function), defined in relation to an approximated objective function in EGO, which is used in the field of optimal design.

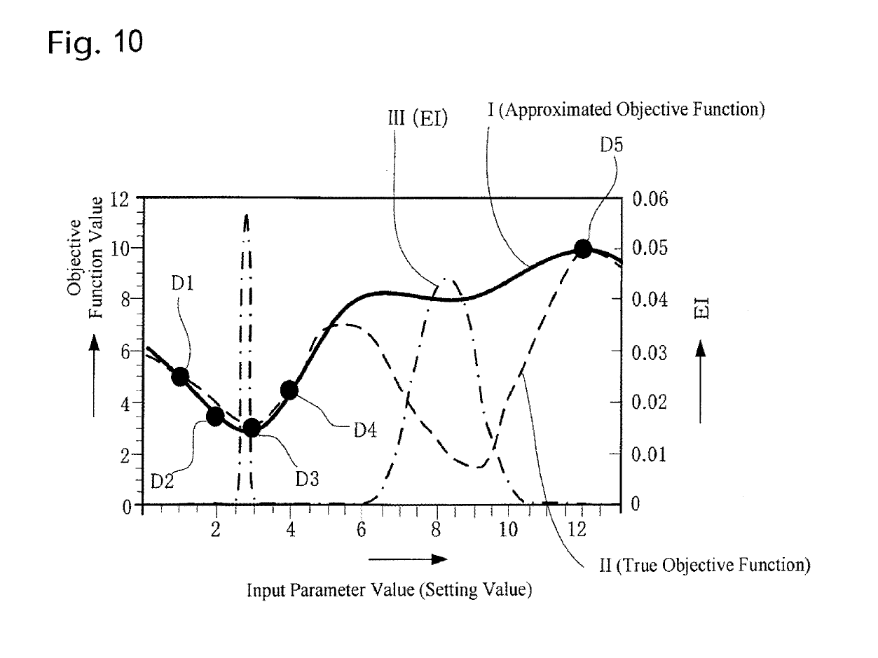

### FORMS FOR EMBODYING THE PRESENT INVENTION

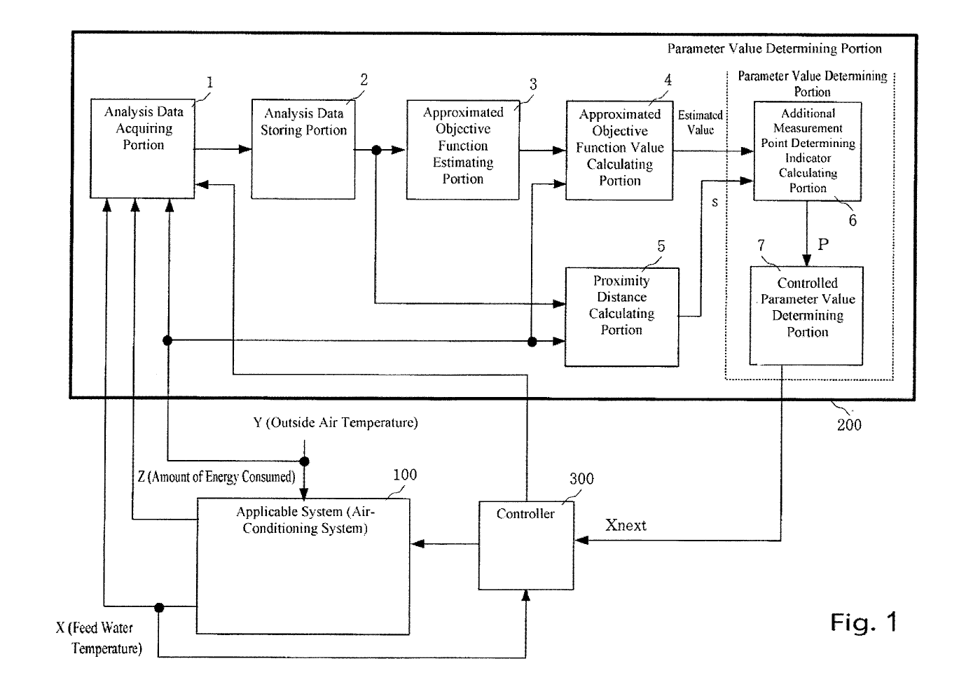

A form of embodiment according to the present invention will be explained below in detail, based on the drawings. FIG. 1 is a block diagram illustrating the critical portions of one form of embodiment of a parameter determining device used in embodying the parameter determining method according to the present invention.

In this figure, 100 is the applicable system, where a parameter determining device 200 according to the present invention is provided for this applicable system 100. Moreover, a controller 300, into which the value of a controlled parameter X, described below, which is determined in the parameter determining device 200, is inputted as a setting value Xnext, is provided between the parameter determining device 200 and the applicable system 100.

The parameter determining device 200 is enabled through hardware, comprising a processor and a storage device, and through a program that enables a variety of functions in cooperation with this hardware, and is provided with an analysis data acquiring portion 1, an analysis data storing portion 2, an approximated objective function estimating portion 3, an approximated objective function value calculating portion 4, a proximity distance calculating portion 5, an additional measurement point determining indicator calculating portion 6, and a controlled parameter value determining portion 7.

In the parameter determining device 200, the analysis data acquiring portion 1 obtains, as a set, and stores into the analysis data storing portion 2, the value of the current controlled parameter (parameter subject to setting) X in the applicable system 100, the current non-controlled parameter (a parameter that is not subject to setting) Y in the applicable system 100, and the current value for an evaluation parameter (evaluation indicator) Z in the applicable system 100, as the analysis data (the obtained data) from the applicable system 100.

In this form of embodiment, the applicable system 100 is an air-conditioning system, where the controlled parameter X is the feed water temperature to the load equipment from the heat source equipment within the air-conditioning system, the non-controlled parameter Y is the outside air temperature, and the evaluation parameter Z is the is the amount of energy consumed in the operation of the air-conditioning system.

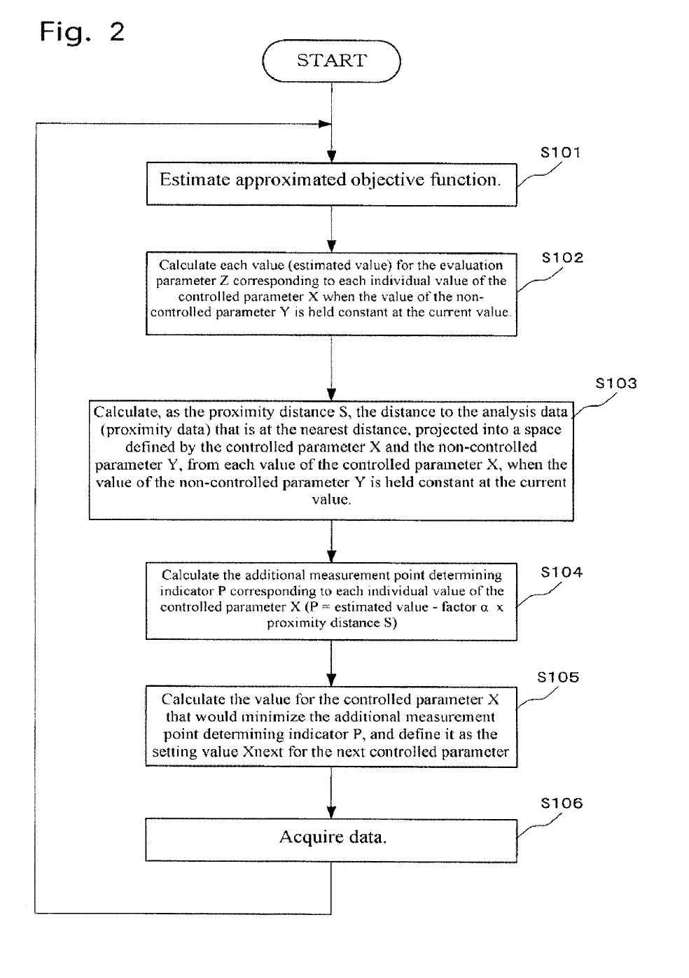

The functions of the various portions in the parameter determining device 200 will be explained below, together with the operations thereof, following the flow chart presented in FIG. 2.

### [Acquisition of Analysis Data]

The analysis data acquiring portion 1 receives an instruction from the controller 300, to acquire the current analysis data (the set of X, Y, and Z) in the applicable system 100, to store it in the analysis data storing portion 2. In the present example, as the initial state it is assumed that six points of analysis data have been acquired from the applicable system 100 and stored in the analysis data storing portion 2.

### [Estimating the Approximated Objective Function]

The approximated objective function estimating portion 3 estimates, based on the six points of analysis data that are stored in the analysis data storing portion 2, an approximated objective function that has, as input variables, the controlled parameter X and the non-controlled parameter Y, and has as an output variable the evaluation parameter Z. (Step S101)

Note that in the present form of embodiment the approximated objective function estimating portion 3 estimates an approximated objective function corresponding to a functional equation that has been established in advance; however, insofar as a correspondence is defined between the controlled parameter X and the non-controlled parameter Y that are the input variables and the evaluation parameter Z that is the output variable, the objective function may be expressed in any form. For example, it may be a model constructed using a case-based system (referencing, for example, Patent Document 2).

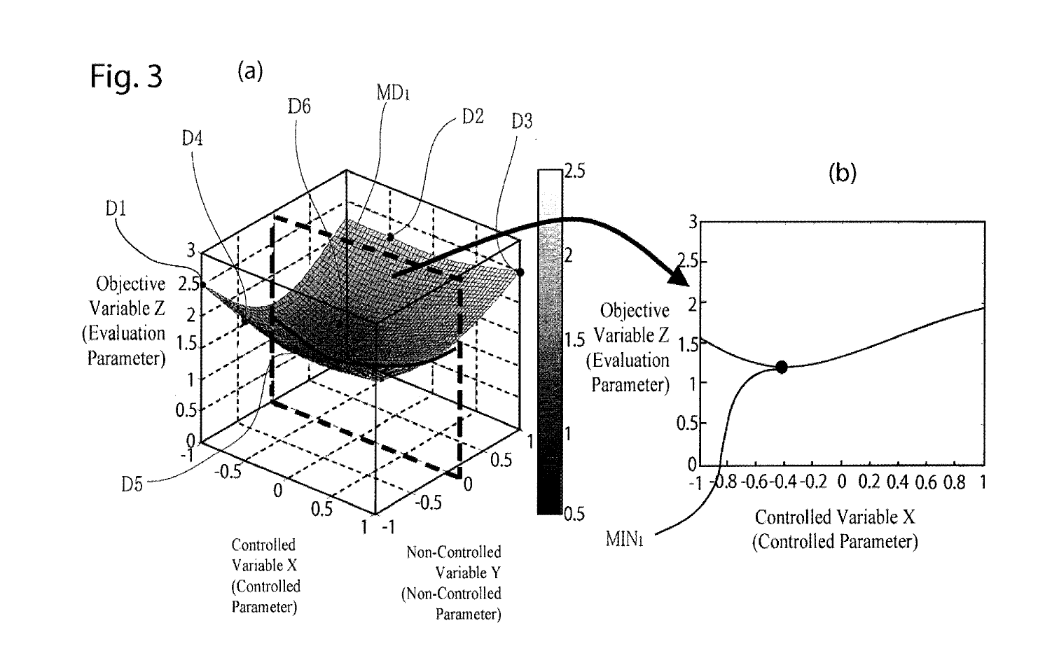

FIG. 3 (a) illustrates an example of an approximated objective function estimated in the approximated objective function estimating portion 3. In this figure, D1 through D6 are analysis data, and MD₁ is an approximated objective function that is estimated based on the analysis data D1 through D6. In this example, the approximated objective function MD₁ is produced through functional interpolation from the analysis data, generated within the three-dimensional space defined by the controlled parameter (controlled variable) X, the non-controlled parameter (non-controlled variable) Y, and the evaluation parameter (the objective variable) Z.

### [Calculating the Approximated Objective Function Value (Estimated Value)]

The approximated objective function value calculating portion 4, upon estimation of the approximated objective function MD₁ by the approximated objective function estimating portion 3, calculates the individual values for the evaluation parameter Z (the individual values of the approximated objective function (estimated values)) corresponding to the individual values of the controlled parameter X for the case wherein the current value of the non-controlled parameter Y is held stationary. (Step S102)

To express this more intuitively, the three-dimensional space that is defined by the controlled parameter X, the non-controlled parameter Y, and the evaluation parameter Z is cut at the current value of the non-controlled parameter Y, as shown by the dotted line in FIG. 3 (a), and the projection (cross-sectional face) of the approximated objective function MD₁ on the cut surface (a two-dimensional space defined by the controlled parameter X and the evaluation parameter Z) is calculated. (See FIG. 3 (b).) In this case, the number of analysis data is small, so that the objective function cannot be approximated with adequate accuracy, and thus the minimal value MIN₁ on this cross-section of the approximated objective function MD₁ is not the true optimal value.

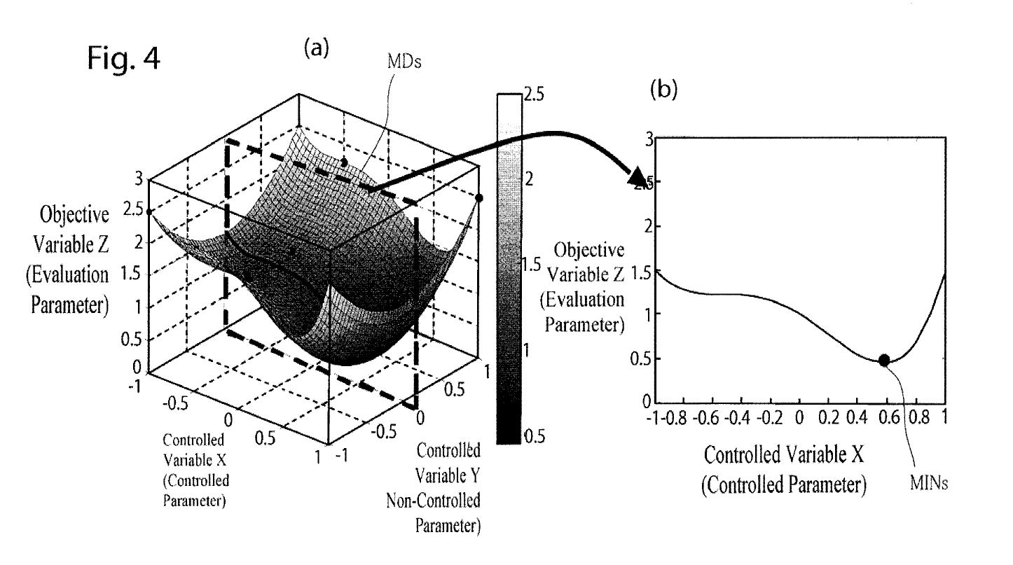

An example of a true objective function MDs relative to the approximated objective function MD₁ will be illustrated referencing FIG. 4 (a). In this case, the three-dimensional space defined by the controlled parameter X, the non-controlled parameter Y, and the evaluation parameter Z is sectioned at the current value of the non-controlled parameter Y, and when the projection (sectional face) of the true objective function MDs on this sectioned surface (the two-dimensional space defined by the controlled parameter X and the evaluation parameter Z) is calculated (referencing FIG. 4 (b)), the minimal value MIN_{S} on the sectioned face of the true objective function MDs will be the true minimal value.

As can be understood by comparing FIG. 3 (b) and FIG. 4 (b), here there is a substantial difference between the value of the controlled parameter X corresponding to the minimal value MIN₁ on the sectioned face of the approximated objective function MD₁ in FIG. 3 (b) relative to the value of the controlled parameter X corresponding to the true minimal value MIN_{S}. Consequently, regardless of the amount of training performed with the minimal value on the sectioned face of the approximated objective function, estimated by the approximated objective function estimating portion 3, as the optimal value, it will not be possible to arrive at the true optimal value MIN_{S}.

### [Calculating the Proximity Distances]

When the approximated objective function value calculating portion 4 calculates the individual values (estimated values) of the evaluation parameter Z corresponding to the individual values of the controlled parameter X in the case of the value of the non-controlled parameter Y being held constant in the approximated objective function MD₁, the proximity distance calculating portion 5 calculates, as the proximity distance s for each individual controlled parameter X value, the distance from each individual value for the controlled parameter X, in the case wherein the current value of the non-controlled parameter Y is held constant, to the analysis data with the nearest distance (the proximity data) that is projected into the input variable space that is defined by the controlled parameter X and the non-controlled parameter Y. (Step S103.)

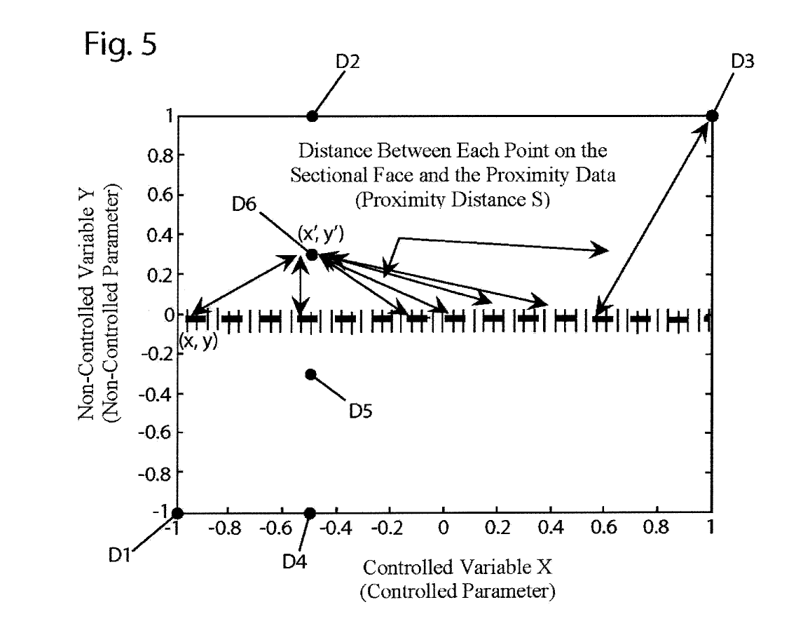

FIG. 5 illustrates the state wherein the proximity distance s is calculated in Step S104. FIG. 5 is a diagram of the input variable space, defined by the controlled parameter X and the non-controlled parameter Y when viewed from the axial direction of the evaluation parameter Z. In this diagram, for the evaluation data D1 through D6, the points that exist in the three-dimensional space are shown as points that are projected onto the input variable space that is defined by the controlled parameter X and the non-controlled parameter Y. The proximity distance calculating portion 5 calculates, for the analysis data D1 through D6 that is stored in the analysis data storing portion 2, the distance from each of the values of the controlled parameter X, to the analysis data (the proximity data) that has the nearest distance, projected onto the input variable space that is defined by the controlled parameter X and the non-controlled parameter Y, doing so as the proximity distance s for each of the individual values for the controlled parameter Y. For example, the Euclidean distance (s=((x−x′)²+(y−y′)²))^{1/2} is calculated as the distance between two points in the two-dimensional space. Note that in this case a distance other than a Euclidean distance may be used as the distance instead. Moreover, when calculating the distance, the scales for taking the individual parameters are arbitrary, and the distances may be calculated after weighting by the values of either of the parameters.

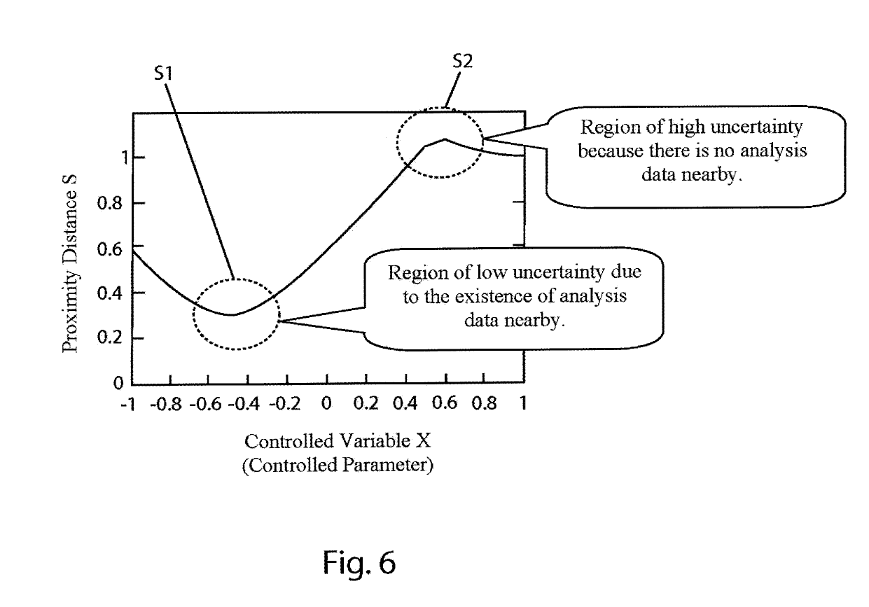

FIG. 6 illustrates the proximity distances s calculated for each of the individual values for the controlled parameter X. In FIG. 6, the region indicated by S1 shows a region wherein the uncertainty is low due to the existence of analysis data nearby, where the region indicated by S2 indicates the region wherein the uncertainty is high because there is no analysis data nearby. The proximity distances S calculated for the individual controlled parameters Y are indicators indicating the “spatial density” of the analysis data used in estimating the approximated objective function in Step S101 (the sparseness of the data that served as the basis for the estimation), and thus can be considered to be indicators indicating the “uncertainty” of the approximated objective function that is projected into the reduced-dimensionality space under the constraint of “the value of the non-controlled parameter Y being held at the current value.”

### [Calculating the Additional Measurement Point Determining Indicator]

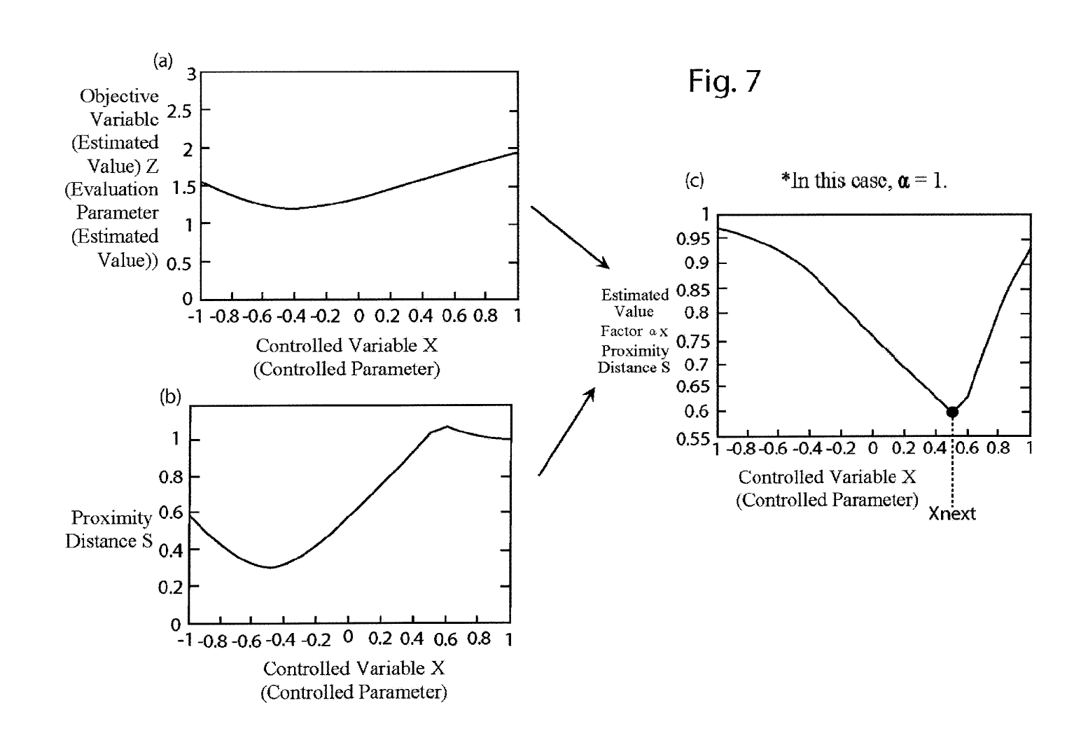

When the proximity distance calculating portion 5 has calculated the proximity distance s for each of the values of the controlled parameter X, the additional measurement point determining indicator calculating portion 6 calculates an additional measurement point determining indicator P (where P=the estimated value−factor α×proximity distance s) corresponding to each of the individual controlled parameters x by subtracting, from the individual values (estimated values) of the evaluation parameter 7 corresponding to the individual values of the controlled parameter X in the case wherein the value of the non-controlled parameter Y is held constant at the current value in the approximated objective function MD₁ that that has been calculated by the approximated objective function value calculating portion 4 (referencing FIG. 7 (a)), a value wherein the proximity distance s corresponding to the individual value of the controlled parameter X, calculated by the proximity distance calculating portion 5 (referencing FIG. 7 (b)), is multiplied by a specific factor α (referencing FIG. 7 (c), Step S104).

Note that while in FIG. 7 the specific factor α is 1, this factor α may be adjusted depending on the complexity and control policies of the applicable system 100. For example, if the priority is on the speed of convergence, then this factor α would be made smaller, but if the priority is on stability, then this factor α would be made larger.

### [Determining the Value of the Controlled Parameter]

When the additional measurement point determining indicator calculating portion 6 has calculated the additional measurement point determining indicators P corresponding to each of the values of the controlled parameter X, then the controlled parameter value determining portion 7 calculates the value for the controlled parameter X that minimizes this calculated additional measurement point determining indicator P, and sets it as the setting value Xnext in the controller 300 for the next controlled parameter X (Step S105).

In the present form of embodiment, the additional measurement point determining indicator P is an indicator that is calculated through combining the proximity distance s, which is an indicator that expresses the “uncertainty” of the approximated objective function when projected onto a reduced-dimensionality space under the constraint of “the case wherein the value of the non-controlled parameter Y is held constant at the current value,” with an indicator that expresses the likelihood of the existence of the true optimal value, calculated from the approximated objective function value that has been acquired. If this is viewed as an indicator wherein, by calculating the value of the controlled parameter X that minimizes the additional measurement point determining indicator P, there would be great value in obtaining a region wherein the uncertainty is high, given the uncertainty in the approximated objective function that has been estimated, while, on the other hand, indicating the potential for the existence of the true optimal value, where if the value of the approximated objective function being quite different from the optimal value indicates that there is little possibility that the optimal value is present, so that the benefit produced would be viewed as low even in a region wherein the uncertainty is high, then it would be as if the EI has been defined in EGO, and a controlled parameter X wherein there would be a high likelihood of improving the optimal value in the approximated objective function that will be updated through the next obtained data would be determined as the setting value Xnext for the next controlled parameter X.

The controller 300 receives the setting value Xnext for the controlled parameter X from a controlled parameter value setting portion 7, and performs control so as to cause the controlled parameter X (which is the feed water temperature in the present example) in the applicable system 100 to go to the setting value Xnext. Following this, the controller 300, after confirming that the controlled parameter X in the applicable system 100 has gone to the setting value Xnext, waits for a specific amount of time to elapse, and then sends a data acquisition command to the analysis data acquiring portion 1.

The analysis data acquiring portion 1 receives the data acquisition command from the controller 300, and acquires, as a set, the value of the controlled parameter X, the value of the non-controlled parameter Y, and the value of the evaluation parameter Z at that time (Step S106), and then stores them in the analysis data storing portion 2 as the next analysis data acquired from the applicable system 100.

After this, the estimation of the approximated objective function of Step S101, the of the approximated objective function value (estimated value) of Step S102, the calculation of the proximity distances s in Step S103, the calculation of the additional measurement point determining indicator P of Step S104, and the determination of the setting value Xnext for the next controlled parameter X of Step S105 are repeated in the same way.

In this way, in the present form of embodiment the approximated objective function, which uses the controlled parameter X and the non-controlled parameter Y as input values and the evaluation parameter Z as an output value, is learned while establishing values for the controlled parameter X wherein there will be a high probability of improving the optimal value of the approximated objective function that is updated through the next obtained data, making it possible to reduce the probability of overlooking the true optimal value, through performing sampling with excellent efficiency and a small number of data points, even in an applicable system 100 that includes a non-controlled parameter Y in the input variables.

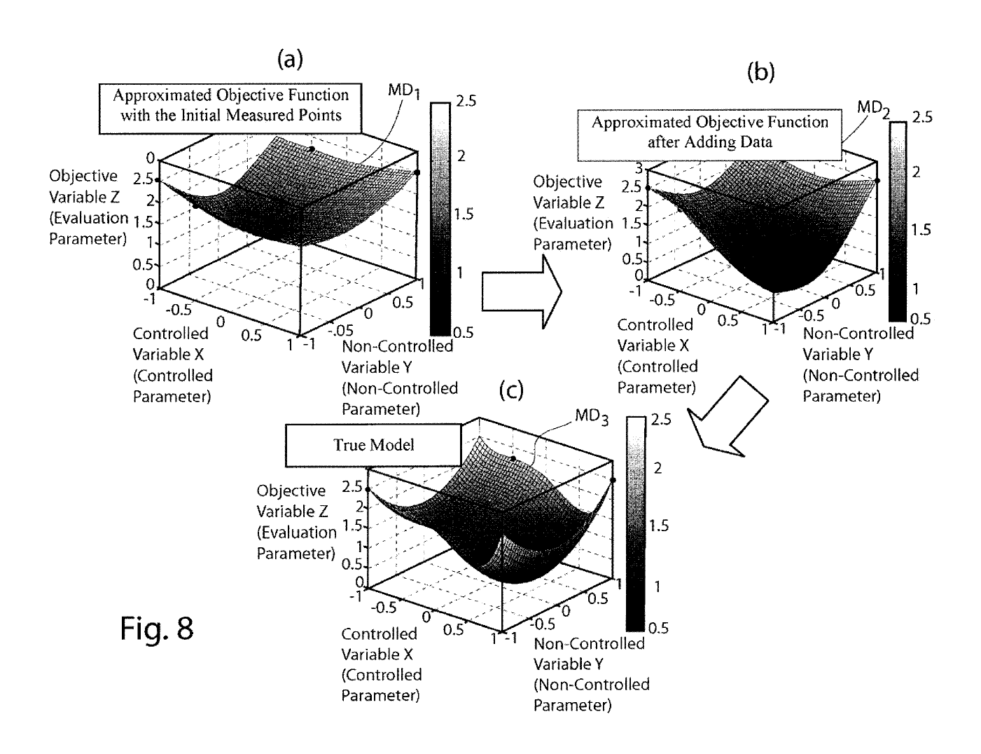

FIGS. 8 (a), (b), and (c) presents examples of changes in the approximated objective function estimated by the approximated objective function estimating portion 3. FIG. 8 (a) shows an approximated objective function MD₁ of the initial measured points based on six points of analysis data, which is improved to the approximated objective function MD₂, as illustrated in FIG. 8 (b) through the acquisition of the subsequent analysis data, which, with a small number of data points, approaches the true objective function MDs (FIG. 8 (c)), making it possible to reduce the possibility that the optimal value will be overlooked.

Note that while in the form of embodiment set forth above the feed water temperature was used for the controlled parameter X and the outside air temperature was used for the non-controlled parameter Y, instead the controlled parameter X may be the flow rate, the airflow rate, the chilled water temperature, the supply air temperature, the number of refrigeration units in operation, or the like, and the non-controlled parameter may be the outside air humidity, the outside air dew point temperature, the outside air enthalpy, the heat load, the number of occupants, or the like.

Additionally, there may be a plurality both of the controlled parameters X and of the non-controlled parameters Y. For example, in the case wherein there are two controlled parameters X and two controlled parameters Y (m=2), then the case wherein the value of the non-controlled parameters Y being held constant at the current values is equivalent to a projection of the five-dimensional space (N=5) that is defined by the two controlled parameters X, the two non-controlled parameters Y, and the evaluation parameter Z into a three-dimensional space (N-m=3) that is defined by the two controlled parameters X and the evaluation parameter Z. In this case, the individual values of the approximated objective function corresponding to the individual values for the controlled parameters X when the values of the non-controlled parameters Y are held constant at their current values are included in the projection to the three-dimensional space (the N-m)-dimensional space) from the five dimensional space (the N-dimensional space) of the approximated objective function (or, more intuitively, in the three-dimensional space (the “sectional surface” of the (N-m)-dimensional space) of the objective function).

Moreover, while the amount of energy consumed was used as the evaluation parameter Z in the form of embodiment set forth above, instead the cost or amount of carbon dioxide exhausted accompanying the operation of the applicable system 100, the operational efficiency, or the like, may be used for the evaluation parameter Z. Moreover, the applicable system 100 is also not limited to being an air-conditioning system, but rather the present invention may be applied similarly to optimizing the operation of a process, such as in a petrochemical plant, or the like.

Moreover, while the additional measurement point determining indicator P in the form of embodiment set forth above was calculated in an additional measurement point determining indicator calculating portion 6 and the value of the controlled parameter that would minimize the additional measurement point determining indicator P was determined in the controlled parameter value determining portion 7, that is, although the parameter value determining portion was structured from an additional measurement point determining indicator calculating portion 6 and a controlled parameter value determining portion 7, that which is essential is the calculation of a controlled parameter that has a high probability of increasing the optimal value in the approximated objective function that is updated by the subsequent obtained data, using the two data that are the approximated objective function value (estimated value) from the approximated objective function value calculating portion 4 and the proximity distances s from the proximity distance calculating portion 5, and there is no limitation to the calculation process of the additional point determining indicator P.

### POTENTIAL FOR USE IN INDUSTRY

The parameter determining method and device according to the present invention, as a parameter determining method and device for estimating an approximated objective function based on data acquired from an applicable system and for determining, from the estimated approximated objective function, a parameter value that has a high probability of improving the approximated objective function that will be estimated next, can be used in a variety of systems such as in optimized operation, and the like, of air-conditioning systems, petrochemical plants, and the like.

### EXPLANATION OF CODES

1: Analysis Data Acquiring Portion
2: Analysis Data Storing Portion
3: Approximated Objective Function Estimating Portion
4: Approximated Objective Function Value Calculating Portion
5: Proximity Distance Calculating Portion
6: Additional Measurement Point Determining Indicator Calculating Portion
7: Controlled Parameter Value Determining Portion
100: Applicable System
200: Parameter Determining Device
3: Controller.

1. A parameter determining method comprising:
a first step for estimating, as an approximated objective function, based on data acquired from an applicable system, an objective function that uses, as input variables, a first parameter that is subject to setting and modification, and a second parameter that is not subject to setting and modification;
a second step for calculating individual values for the approximated objective function corresponding to individual values for the first parameter in a case wherein the value of the second parameter is kept constant at a specific value;
a third step for calculating, as a proximity distance for each individual value for the first parameter, a distance from the individual value of the first parameter to the data that is nearest in distance, projected into an input variable space that is defined by the first parameter and the second parameter; and
a fourth step for determining a value for the first parameter based on the individual values of the approximated objective function corresponding to the individual values of the first parameter when the value of the second parameter is held constant at a specific value, calculated in the second step, and on the proximity distances corresponding to the individual values of the first parameter, calculated in the third step.

2. A parameter determining method as set forth in claim 1, comprising:
a fifth step for using, as a setting value, the value of the first parameter that was determined in the fourth step, and for operating the applicable system to acquire the next data.

3. A parameter determining device comprising:
approximated objective function estimating means for estimating, as an approximated objective function, based on data acquired from an applicable system, an objective function that uses, as input variables, a first parameter that is subject to setting and modification, and a second parameter that is not subject to setting and modification;
approximated objective function value calculating means for calculating individual values for the approximated objective function corresponding to individual values for the first parameter in a case wherein the value of the second parameter is kept constant at a specific value;
proximity distance calculating means for calculating, as a proximity distance for each individual value for the first parameter, a distance from the individual value of the first parameter to the data that is nearest in distance, projected into an input variable space that is defined by the first parameter and the second parameter; and
parameter value determining means for determining a value for the first parameter based on the individual values of the approximated objective function corresponding to the individual values of the first parameter when the value of the second parameter is held constant at a specific value, calculated by the approximated objective function value calculating means, and on the proximity distances corresponding to the individual values of the first parameter, calculated by the proximity distance calculating means.

4. A parameter determining device as set forth in claim 3, comprising:
means for using, as a setting value, the value of the first parameter that was determined by the parameter value determining means, and for operating the applicable system to acquire the next data.
